(19) United States
(12) Patent Application Publication
(10) Pub. No.: US 2016/0309258 A1
(43) Pub. Date: Oct. 20, 2016

(54) SPEAKER LOCATION DETERMINING SYSTEM

(71) Applicant: Qualcomm Technologies International, LTD., Cambridge (GB)

(72) Inventors: Paul HISCOCK, Cambridge (GB); Benjamin CAMPBELL, Cambridge (GB); Jonathan SOLE, Cambridge (GB); Nicholas JONES, Cambridge (GB)

(21) Appl. No.: 14/687,611

(22) Filed: Apr. 15, 2015

(51) Int. Cl. H04R 5/04; H04S 7/00

(52) U.S. Cl. CPC H04R 5/04; H04S 7/302

(57) ABSTRACT

A controller for determining the location of speakers in a system of speakers configured to play out audio signals received according to a wireless communications protocol. The controller configured is to, for each speaker of the system of speakers, transmit a signal to that speaker comprising an indication of a playout time for playing out an identification sound signal comprising the identification data of that speaker. The controller is configured to receive data indicative of a played out identification sound signal from each speaker as received at least two listening locations, wherein relative positional information about the at least two listening locations is known. For each of the at least two listening locations, the controller determines the locations of the speakers of the speaker system relative to the position of one of the at least two listening locations.

### FIELD OF THE INVENTION

This invention relates to determining the location of speakers in a speaker system.

### BACKGROUND

The increasing popularity of home entertainment systems is leading to higher expectations from the domestic market regarding the functionality, quality and adaptability of the associated speaker systems.

Surround sound systems are popular for use in the home to provide a more immersive experience than is provided by outputting sound from a single speaker alone. FIG. 1 illustrates the arrangement of a 5.1 surround sound system 100. This uses six speakers—front left 102, centre 104, front right 106, surround left 108, surround right 110 and a subwoofer 112. Each speaker plays out a different audio signal, so that the listener is presented with different sounds from different directions. The 5.1 surround system is intended to provide an equalised audio experience for a listener 114 located at the centre of the surround sound system. The location of the speakers is constrained to provide this. Specifically, the front left 102 and front right 106 speakers are generally located at an angle α from a line joining the listener 114 to the centre speaker 104. α is between 220 and 300, with the smaller angle preferred for listening to audio accompanying movies, and the larger angle preferred for listening to music. The surround left 108 and right 110 speakers are generally located at an angle β from the line joining the listener 114 to the centre speaker 104, where β is about 110o. The subwoofer 112 does not have such a constrained position, but is generally located at the front of the sound system. The centre, front and surround speakers are of the same size and placed the same distance away from the centrally-positioned listener 114.

FIG. 2 illustrates the arrangement of a 7.1 surround sound system 200. The concept is similar to that of the 5.1 surround sound system, this time utilising eight speakers. The surround speakers of the 5.1 surround sound system have been replaced with surround speakers and rear speakers. The surround left 208 and surround right 210 speakers are located at an angle θ from the line joining the listener 214 to the centre speaker 204, where θ is between 90o and 110o. The rear left 216 and rear right 218 speakers are behind the listener 214 at an angle of φ from the line joining the listener 214 to the centre speaker 204, where φ is between 135o and 150o. As with the 5.1 surround sound system, the centre, front, surround and rear speakers are all of the same size and placed the same distance away from the centrally-positioned listener 214.

Determining the position of the speakers in a speaker system is useful for determining whether the speakers have the required positions for the desired 5.1 (or 7.1) surround sound system. The relative positioning of the speakers can be determined manually by the user, for example using a tape measure. However, this is of limited accuracy and cumbersome in a furnished room.

Thus, there is a need for a technique of providing a more accurate, quicker and less cumbersome way of determining the relative locations of the speakers of a speaker system.

### SUMMARY OF THE INVENTION

According to a first aspect, there is provided a controller for determining the location of speakers in a system of speakers configured to play out audio signals received according to a wireless communications protocol, the controller configured to: for each speaker of the system of speakers, transmit a signal to that speaker comprising an indication of a playout time for playing out an identification sound signal comprising identification data of that speaker; receive data indicative of a played out identification sound signal from each speaker as received at at least two listening locations, wherein relative positional information about the at least two listening locations is known; for each of the at least two listening locations, compare the relative time of transmission to that listening location of each of the played out identification sound signals; and based on those comparisons, determine the locations of the speakers of the speaker system relative to the position of one of the at least two listening locations.

The controller may be configured to, for each speaker of the system of speakers, transmit one or more signals to that speaker comprising indications of threat least two playout times for playing out an identification sound signal comprising the identification data of that speaker. The controller may transmit the same indication of the playout time to each speaker of the system of speakers. The controller may transmit different indications of the playout time to each speaker of the system of speakers.

The controller may, for each speaker of the system of speakers, transmit a signal to that speaker comprising the identification data for that speaker. That signal comprising the identification data for a speaker and the signal comprising an indication of a playout time for that speaker may form part of the same signal.

Suitably, the identification data for each speaker is orthogonal to the identification data of the other speakers in the system of speakers. Suitably, the identification sound signal for each speaker is an identification chirp sound signal.

The positions of three listening locations may be known relative to each other. The direction of the second listening location relative to the first listening location may be known. The positions of two listening locations may be known relative to each other, and the direction of one speaker of the system of speakers may be known relative to the position of one of the two listening locations.

The controller may further comprise a store, wherein the controller is configured to: store each speaker's identification data; and perform the claimed comparison by: correlating the received data indicative of played out identification sound signals received from the speakers against the stored identification data to form a correlation response; and determining the locations of the speakers of the speaker system relative to the position of one of the at least two listening locations based on the correlation response.

The controller may assign a channel to each speaker based on the determined locations of the speakers.

The controller may determine parameters of audio signals played out from the speakers so as to align those played out audio signals at a further listening location; and control the speakers to play out audio signals with the determined parameters.

The controller may determine amplitude of audio signals played out from the speakers so that the amplitudes of the played out audio signals are matched at the further listening location. The controller may determine playout time of audio signals played out from the speakers so that the played out audio signals are time synchronised at the further listening location. The controller may determine phase of audio signals played out from the speakers so that the phases of the played out audio signals are matched at the further listening location.

The controller may receive data indicative of a sound signal emitted by an object as received at at least three speakers of the system of speakers; and determine the location of the object by comparing the time-of-arrival of the sound signal at each of the at least three speakers of the system of speakers.

The internal delays at the speakers may be unknown to the controller. In this case, the controller may receive data indicative of a played out identification sound signal from each speaker as received at a further at least two listening locations, wherein relative positional information about the at least two listening locations and the further at least two listening locations is known; for each of the at least two listening locations and further at least two listening locations, compare the relative time of transmission to that listening location of each of the played out identification sound signals, thereby determining the time of flight of each identification sound signal from the speaker to the listening location and the internal delay of the speaker; and based on those comparisons, determine the location of the speakers of the speaker system relative to the position of one of the at least two listening locations.

According to a second aspect, there is provided a method of determining the location of speakers in a system of speakers configured to play out audio signals received according to a wireless communications protocol, the method comprising: for each speaker of the system of speakers, transmitting a signal to that speaker comprising an indication of a playout time for playing out an identification sound signal comprising identification data of that speaker; receiving data indicative of a played out identification sound signal from each speaker as received at at least two listening locations, wherein relative positional information about the at least two listening locations is known; for each of the at least two listening locations, comparing the relative time of transmission to that listening location of each of the played out identification sound signals; and based on those comparisons, determining the locations of the speakers of the speaker system relative to the position of one of the at least two listening locations.

### BRIEF DESCRIPTION OF THE DRAWINGS

The present invention will now be described by way of example with reference to the accompanying drawings. In the drawings:

FIG. 1 illustrates a 5.1 surround sound system;

FIG. 2 illustrates a 7.1 surround sound system;

FIG. 3 illustrates an unsymmetrical speaker system;

FIG. 4 illustrates a method of determining the location of speakers in a speaker system;

FIG. 5 illustrates the location of a speaker relative to three listening locations;

FIG. 6 illustrates a correlation response at a listening location from identification signals received from speakers of a speaker system;

FIG. 7 illustrates an exemplary controller or mobile device; and

FIG. 8 illustrates an exemplary speaker.

### DETAILED DESCRIPTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The following describes wireless communication devices for transmitting data and receiving that data. That data is described herein as being transmitted in packets and/or frames and/or messages. This terminology is used for convenience and ease of description. Packets, frames and messages have different formats in different communications protocols. Some communications protocols use different terminology. Thus, it will be understood that the terms “packet” and “frame” and “messages” are used herein to denote any signal, data or message transmitted over the network.

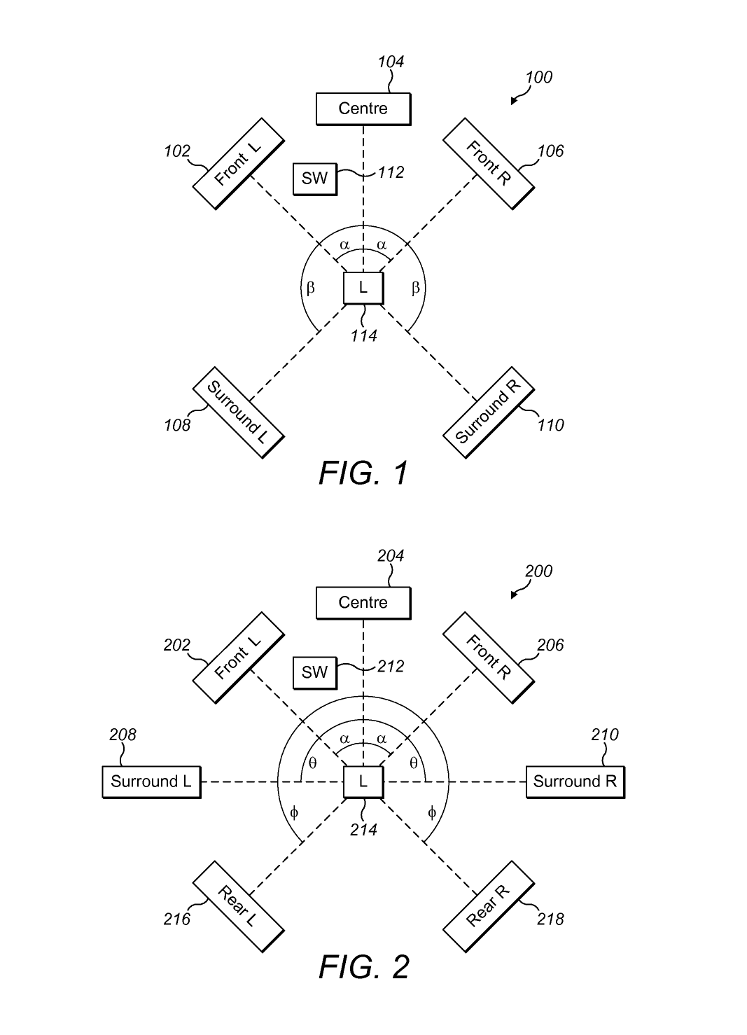

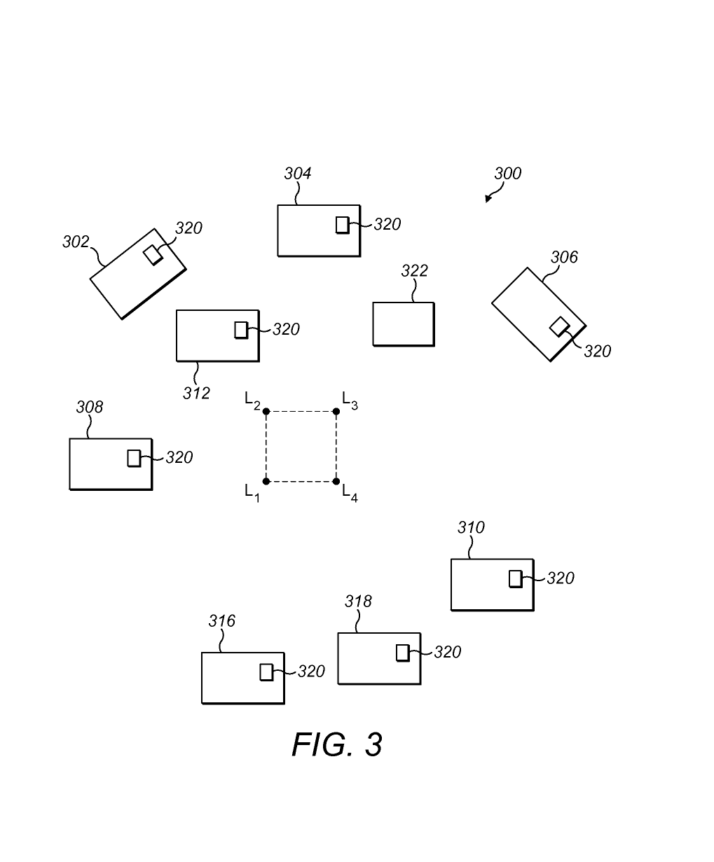

The following description describes a system of speakers, and methods for determining the locations of those speakers. The speakers may be arranged in a symmetrical 5.1 or 7.1 formation, as illustrated in FIGS. 1 and 2. Alternatively, the speakers may be arranged in an unsymmetrical formation. FIG. 3 illustrates an example of a speaker system 300 which is not symmetrical. The speaker system 300 comprises eight speakers 302, 304, 306, 308, 310, 312, 316 and 318. The speakers each comprise a wireless communications unit 320 that enables them to operate according to a wireless communications protocol, for example for receiving audio to play out. The speakers each also comprise a speaker unit for playing out audio. Suitably, the speakers are all in line-of-sight of each other.

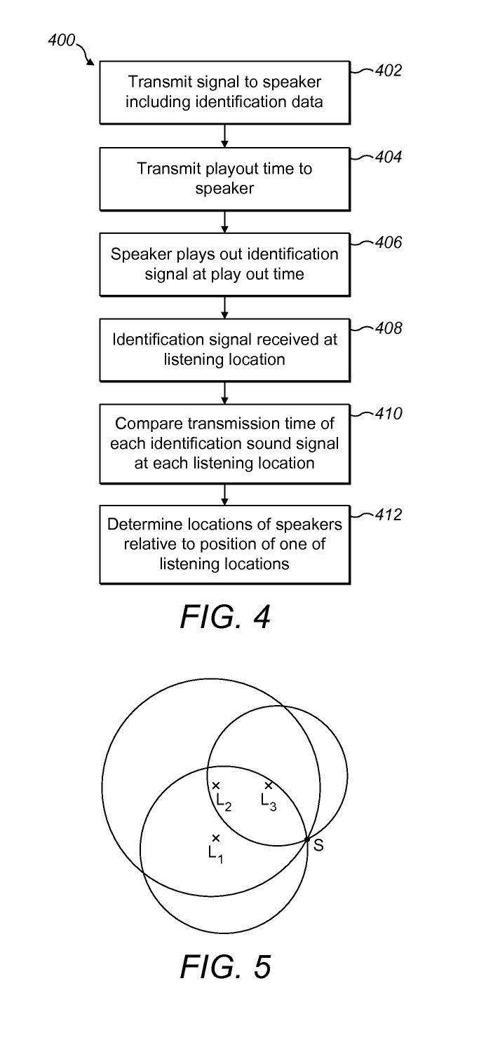

FIG. 4 is a flowchart illustrating a method of determining the location of speakers in a speaker system. This method applies to any speaker system. For convenience, the method is described with reference to the speaker system of FIG. 3. At step 402, a signal is transmitted to each speaker of the speaker system. This signal includes identification data for that speaker. At step 404, a signal is transmitted to each speaker of the speaker system which includes a playout time or data indicative of a playout time for playing out an identification sound signal including the identification data of the speaker. At step 406, each speaker responds to receipt of the signal at step 404 by playing out its identification sound signal at the playout time identified from the signal in step 404. At step 408, the identification sound signal from each speaker is received at a listening location. At step 410, the time of transmission of each played out identification sound signal is compared, for each listening location that the identification sound signal is received at. For example, the playout time of an identification sound signal may be compared to the time-of-arrival of that identification sound signal at the listening location, for each listening location that the identification sound signal is received at. At step 412, the locations of the speakers are determined relative to the position of one of the listening locations.

The identification sound signals from the speakers are received at each listening location by a microphone. This microphone may, for example, be integrated into a mobile device such as a mobile phone, tablet or laptop. Alternatively, the microphone may be integrated into a speaker of the speaker system.

There are at least two listening locations, and relative positional information about those at least two listening locations is known.

Relative positional information may be known which comprises the relative positions of the listening locations. For example, in one implementation, the relative positions of the at least three listening locations are known with respect to each other. FIG. 3 illustrates an example of this, in which four listening locations, L1, L2, L3 and L4 are shown. These listening locations are the corners of a square, the sides of which have a known length. For example, the user may be provided with a square piece of material such as card. The length of the sides of the card is known. For example, it may be 1 m. Thus, the relative positions of the listening locations at the corners of the square are known with respect to each other.

Relative positional information may be known which comprises the relative directions of the listening locations. For example, in one implementation, the relative directions of at least three listening locations are known with respect to each other. In an example in which the listening locations are at speakers of the system of speakers, the direction of a first speaker (incorporating the microphone of a first listening location) relative to a second speaker (incorporating the microphone of a second listening location) and a third speaker (incorporating the microphone of a third listening location) is known. For example, it may be known that the first speaker (which is the central speaker) is to the left of the second speaker (which is the front left speaker) and to the right of the third speaker (which is the front right speaker). The known relative directions of the speakers can solve the left-right and front-back ambiguity that arises when the speaker locations are unknown.

Relative positional information may be known which comprises the relative positions of two listening locations, and the direction of one of the speakers of the speaker system relative to one of the listening locations. For example, it may be known that a particular speaker is the front left speaker which is to the front and left of the first listening location. This enables the symmetry ambiguity that arises when only relative positions of two listening locations are known to be solved.

Reverting to the example of FIG. 3, in which the relative positions of the four listening locations, L1, L2, L3 and L4 are known. A microphone at each listening location receives the identification sound signal from each speaker. The same microphone may be utilised at each listening location. For example, the user may place the microphone device (such as their mobile phone) at each listening location in turn, and receive an identification sound signal from each speaker at each listening location. In this case, at step 404, each speaker is provided with a different playout time for playing out an identification sound signal to be received at each listening location. For example, for the implementation shown on FIG. 3, each speaker is provided with a first playout time for an identification sound signal which is to be received at listening location L1, a second playout time for an identification sound signal which is to be received at listening location L2, a third playout time for an identification sound signal which is to be received at listening location L3, and a fourth playout time for an identification sound signal which is to be received at listening location L4. Alternatively, a different microphone may be utilised at each listening location. In this case, at step 404, a speaker may be provided with a single playout time for playing out an identification sound signal, which is subsequently received at all the listening locations.

The N listening locations Lₙ can be defined in terms of 3D coordinates, where Lₙ=[xₙyₙzₙ]. For example, if the listening locations are arranged in a square, as shown in FIG. 3, then two sides of the square can be aligned with the X axis and two sides of the square can be aligned with the Y axis. For example L₁→L₄ could be aligned with the X-axis and L₁→L₂ with the Y-axis. If the listening locations are also in a horizontal plane, for example on the floor, then the Z axis can be defined to be the vertical axis orthogonal to the XY plane. In this case L₁ could be defined to be the origin. If there are M speakers, each speaker has an unknown 3D position Pₘ where Pₘ=[iₘjₘkₘ] and iₘ, jₘ and kₘ are 3D coordinates relative to the defined origin. Hence, for M speakers there are 3×M unknown variables. In an alternative 2D axes system, without a Z-axis, there would be 2×M unknown variables and hence fewer measurements need to be made.

The time measurements that are made within step 410 may be described in terms of four components according to:

T_{n,m}=τₑ+τₙ+τ_{mlc}+τ_{n,m} (equation 1)

Where:

T_{n,m} is the total time delay that is measured from the desired playout time of speaker unit n to listening location Lₘ and is determined within step 410.

τₑ is the relative time error due to synchronisation imperfections between a speaker unit and the microphone.

τₙ is the internal delay within each speaker unit n that arises due to additional digital processing, transmission delays and delays through analogue filtering components.

τ_{mic} is the delay of the signal through the receiving microphone to its digital representation.

τ_{n,m} is the time delay due to the propagation of the identification sound signal from the output of the speaker n to the input of the microphone at listening location m, i.e. the time of flight.

In practice, τₑ represents an error than cannot be solved for and ultimately determines the accuracy of the speaker position estimates. Preferably, τₑ should be less than ±20 μs, which equates to a final position accuracy in the order of a millimetre.

The internal delays τₙ and τ_{mic} may be determined during the design or manufacture of each speaker and microphone. These constant delays can be accounted for in either determining when the identification data is sent by each speaker, or included in step 410.

There and N×M delay measurements τ_{n,m}, which relate to the speaker locations Pₙ and listening locations according to,

$$\vert \vert {P}_{n} - {L}_{m} \vert \vert ≅ ( {T}_{n , m} - {τ}_{n} - {τ}_{mic} ) v {\vert}_{m = 1. . M}^{n = 1. . N} \qquad ( equation 2 )$$

where v is the speed of sound.

Equation 2 is a set of simultaneous equations, which can be solved or minimised to obtain estimates of the speaker positions \hat{P}ₙ according to:

$$\begin{matrix}argmin \\ \hat{{P}_{n}}\end{matrix} {\sum }_{m = 1}^{M} {\sum }_{n = 1}^{N} {[ \vert \vert \hat{{P}_{n}} - {L}_{m} \vert \vert - ( {T}_{n , m} - {τ}_{n} - {τ}_{mic} ) v ]}^{2} \qquad ( equation 3 )$$

In order to solve equation 3 there must be at least 3×N independent delay measurements T_{n,m}.

Alternatively, the delays τₙ and τ_{mic} can be determined by making more measurements at more listening locations and then solving:

$$\begin{matrix}argmin \\ \hat{{P}_{n}} , \hat{{τ}_{n}} , \hat{{τ}_{mic}}\end{matrix} {\sum }_{m = 1}^{M} {\sum }_{n = 1}^{N} {[ \vert \vert \hat{{P}_{n}} - {L}_{m} \vert \vert - ( {T}_{n , m} - \hat{{τ}_{n}} - \hat{{τ}_{mic}} ) v ]}^{2} \qquad ( equation 4 )$$

The speaker system of FIG. 3 may further include controller 322. Controller 322 may, for example, be located in a sound bar. Controller 322 may perform steps 402 and 404 of FIG. 4. The controller may transmit the signals of step 402 and/or 404 in response to the user initiating the location determination procedure by interacting with a user interface on the controller, for example by pressing a button on the controller. Alternatively, the controller may transmit the signals of step 402 and/or 404 in response to the user initiating the location determination procedure by interacting with the user interface on a mobile device. The mobile device then signals the controller 322 to transmit the signals of steps 402 and/or 404. The mobile device may communicate with the controller in accordance with a wireless communications protocol. For example, the mobile device may communicate with the controller using Bluetooth protocols. The controller may transmit the signals of steps 402 and 404 to the speakers over a wireless communications protocol. This may be the same or different to the wireless communications protocol used for communications between the controller and the mobile device.

Alternatively, a mobile device may perform steps 402 and 404 of FIG. 4. This mobile device may be the microphone device at one of the listening locations. The mobile device may transmit the signals of steps 402 and/or 404 in response to the user initiating the location determination procedure by interacting with a user interface of the mobile device. The mobile device may communicate with the speakers in accordance with a wireless communications protocol, such as Bluetooth.

At step 402, a signal is transmitted to each speaker comprising identification data for that speaker. Alternatively, each speaker may already store its identification data. For example, the identification data of a speaker may be hardwired to it. As a further example, a speaker may have a selector switch which determines its identification data.

At step 404, a single playout time may be transmitted to the speaker. Alternatively, a plurality of playout times may be transmitted to the speaker. The speaker responds by playing out its identification sound signal at each of the playout times at step 406. The plurality of playout times may be transmitted to the speaker by incorporating into the signal transmitted to the speaker an initial playout time and a period between retransmissions. The speaker responds by playing out its identification sound signal at the initial playout time, and additionally at intervals of the period. The period may be fixed. For example, the period may be 100 ms. Alternatively, the period may vary with time in a known manner. For example the period between playing out the identification sound signal may increase over time. The signal transmitted to the speaker may also include an indication of the number of times the identification sound signal is to be played out by the speaker. This may be a finite number. For example, it may be ten. Alternatively, there may be no limit to the number of times the identification sound signal is played out by the speaker. The speaker may continue to play out its identification sound signal at the intervals determined by the received period until the speaker receives a signal instructing it to stop playing out the identification sound signal. The speaker responds to a signal instructing it to stop playing out its identification sound signal by ceasing the playout of its identification sound signal. Suitably, this is the case even if the speaker has not yet reached the number of playouts originally indicated to it.

The identification data may be transmitted to the speakers prior to the user initiating the current location determination procedure. For example, when a speaker is initially installed into the speaker system, it may be assigned identification data (step 402) which is unique to it within the speaker system. The speaker stores this identification data. For subsequent location determination procedures within that system of speakers, the speaker transmits an identification sound signal comprising the identification data assigned to it at the initial installation. On each subsequent location determination procedure, the speaker receives a playout time (step 404), and plays out the stored identification data in the identification sound signal at the playout time (step 406). Subsequent location determination procedures may be performed, for example, because the position of one or more speakers has been moved.

The microphone device at a listening location receives the identification sound signals played out from each speaker in the speaker system. The microphone device may then relay the received identification sound signals onto a location-determining device. The location-determining device may be the controller 322. The location-determining device may be a mobile device, for example the user's mobile phone. Alternatively, the microphone device may extract data from the identification sound signals, and forward this data onto the location-determining device. This data may include, for example, the identification data of the identification sound signals, absolute or relative time-of-arrivals of the identification sound signals, absolute or relative amplitudes of the identification sound signals, and absolute or relative phases of the identification sound signals. The location-determining device receives the relayed or forwarded data from the microphone at each listening location.

For each listening location and speaker combination, the location-determining device compares the transmission time of the played out identification sound signal (step 410). For example, the location-determining device compares the playout time of the played out identification sound signal. The location-determining device determines the time lag between the time-of-arrival and the playout time for each listening location/speaker combination to be the time-of-arrival of the identification sound signal minus the playout time of that identification sound signal. The location-determining device determines the distance between the speaker and the listening location in each combination to be the time lag between those two devices multiplied by the speed of sound in air. The location-determining device then determines the locations of the speakers from this information using simultaneous equations (step 412) (see equations 2-4). This can be illustrated graphically as on FIG. 5. Once the distance of the speaker S from each of three listening locations L1, L2 and L3 is known, the location of the speaker S is determined to be the intersection of the three spheres surrounding the three listening locations, each sphere having a radius equal to the distance of the speaker S from that listening location. In this way, the location-determining device resolves the location of the speakers of the speaker system relative to the position of a listening location.

Alternatively, the microphone device at a listening location may determine the distance to the transmitting speaker, as described above in respect of the location-determining device. The microphone device may then transmit the determined distance to the location-determining device. In this implementation, the playout time of the transmitting speaker and its identification data is initially transmitted to the microphone device. The microphone device stores the playout time and identification data of the speaker.

Suitably, the identification data of each speaker is unique to that speaker within the speaker system 300. Suitably, the identification data of each speaker is orthogonal to the identification data of the other speakers within the speaker system 300. Suitably, the identification data is capable of being successfully auto-correlated. For example, the identification data may comprise an M-sequence. In this example, each speaker of the speaker system is assigned a different M-sequence. Alternatively, the identification data may comprise a Gold code. In this example, each speaker of the speaker system is assigned a different Gold code. Alternatively, the identification data may comprise one or more chirps, such that the identification sound signal of a speaker is an identification chirp sound signal. In this example, each speaker of the speaker system is assigned a differently coded chirp signal. Chirps are signals which have a frequency which increases or decreases with time. Suitably, the centre frequency and the bandwidth of each coded chirp is selected in dependence on the operating frequency range of the speaker for which that coded chirp is to be the identification data. For example, a tweeter speaker has a different operating frequency range to a woofer speaker. The coded chirp for the tweeter speaker is selected to have a centre frequency and bandwidth within the frequency range of the tweeter speaker. Similarly, the coded chirp for the woofer speaker is selected to have a centre frequency and bandwidth within the frequency range of the woofer speaker. The identification sound signal of each speaker may be audible. Alternatively, the identification sound signal of each speaker may be ultrasonic.

The device which performs the comparison step 410 of FIG. 4 initially stores the identification data of each speaker. This comparison device may also store(s) the playout times of the identification sound signal of each speaker for that location determining process. This comparison device may perform the comparison by initially correlating the data received from the speakers at the listening location against the stored identification data for the speakers. Since the identification data of one speaker is orthogonal to the identification data of the other speakers in the speaker system, the received data from one speaker correlates strongly with the stored identification data of that speaker and correlates weakly with the stored identification data of the other speakers in the system. The comparison device thereby identifies which identification sound signals are received from which speakers in the speaker system.

In the case that the identification data comprises chirps, the coded chirp in each chirp signal may be selected to be a power-of-2 in length. In other words, the number of samples in the chirp is a power-of-2. This enables a power-of-2 FFT (fast fourier transform) algorithm to be used in the correlation without interpolating the chirp samples. For example, a Cooley-Tukey FFT can be used without interpolation. In contrast, M-sequences and Gold codes are not a power-of-2 in length and so interpolation is used in order to use a power-of-2 FFT algorithm in the correlation.

If the identification data of each speaker is orthogonal to the identification data of the other speakers within the speaker system 300, then identification sound signals received concurrently from the speakers can be distinguished as described above. Thus, the speakers of the speaker system may all play out their identification sound signals at the same time. This may happen because the device which transmits the playout times to the speakers at step 404 of FIG. 4 sends the same playout time message to each speaker. For example, this device may encapsulate the playout time in a broadcast packet and broadcast that packet, which is subsequently received by all the speakers. All the speakers respond by playing out their identification sound signals at the playout time indicated in the broadcast packet. Alternatively, the device which transmits the playout times to the speakers at step 404 of FIG. 4 may send a message to each speaker which is individually addressed to that speaker, and the message to each speaker comprises the same playout time. For example, the device may incorporate the playout time in a sub-channel message of a broadcast packet which is addressed to an individual speaker, and broadcast that packet. Only the individually addressed speaker responds to this by playing out its identification sound signal at the playout time.

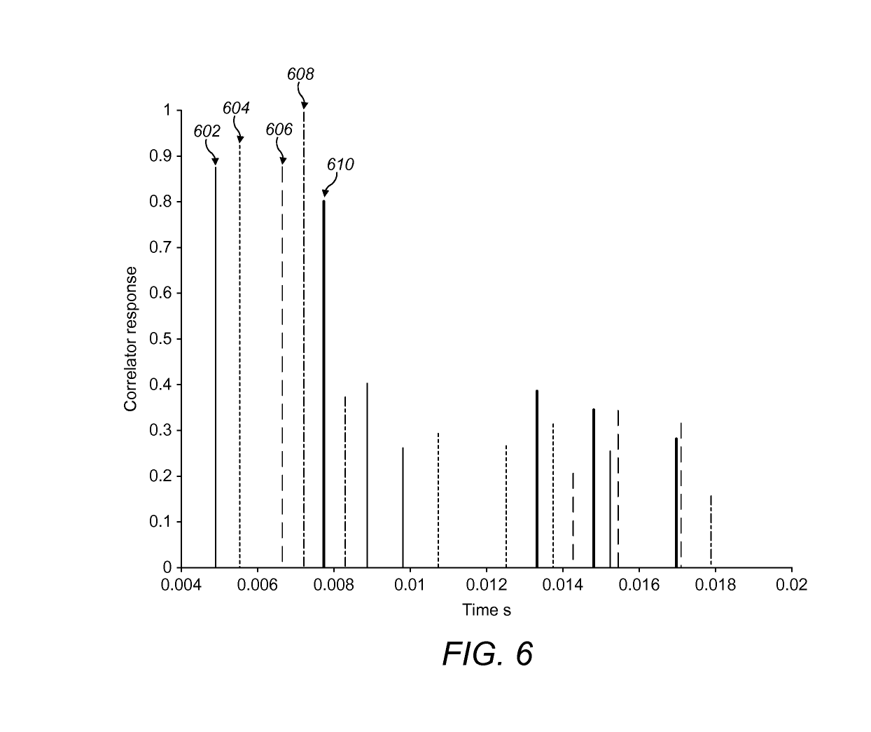

If the speakers in the speaker system are instructed to play out their identification sound signals simultaneously, then the microphone device at a listening location receives the identification sound signals concurrently. FIG. 6 illustrates an example correlation response of identification sound signals received at a listening location from five speakers of a speaker system in a room. Each of the first five correlation peaks 602, 604, 606, 608, 610 represent the magnitude and relative time lags of different identification sound signals received at the microphone device at the listening location. The subsequent smaller peaks are spurious reflections from around the room and are ignored.

The source speaker of each received identification sound signal is determined as described above. Then, the time lag and distance to that speaker from that listening location is determined as described above.

The accuracy of the distance estimate, from each speaker to each listening location, is limited by the bandwidth of the identification sound signal that is sent. In a receiver that uses a correlator response to determine time and distance, for example the response shown in FIG. 6, the resolution is limited by the spacing of the correlator bins. For an identification sound signal with a bandwidth F_{bW} Hz the time resolution of each bin is 1/F_{bw} seconds. Hence, in a system that determines timing using the index of the correlator bin with the largest magnitude there is an error of

$$\pm \frac{1}{2 {F}_{bw}} .$$

The resolution can be improved by interpolating between the maximum peak and its nearest neighbour. The interpolation could be linear. Alternatively, the interpolation could fit a sinc function or other interpolation techniques.

If the identification data of each speaker is not orthogonal to the identification data of the other speakers within the speaker system 300, then identification sound signals received concurrently from the speakers cannot be distinguished. Thus, the speakers of the speaker system may play out their identification sound signals at different times. This may happen because the device which transmits the playout times to the speakers at step 404 of FIG. 4 sends different playout times to the speakers. The device may transmit the identification data of a speaker to that speaker with an instruction to play out its identification sound signal immediately. Once that speaker has played out its identification sound, the device may then transmit the identification data of another speaker to that other speaker with an instruction to play out its identification sound signal immediately.

The device which transmits the identification data and playout times to the speakers at steps 402 and 404 of FIG. 4 may send both the identification data and playout time to a speaker in the same packet. The device may transmit the identification data to each speaker in the system of speakers at the same time with an instruction to play out their identification sound signals immediately. In this way, all of the speakers play out their identification sound signals at the same time. The delays between messages being transmitted by the device and received by the speakers are the same or constant and known. If they are constant and known but different, then this is taken into account when determining the time lags at step 410 of FIG. 4. Each speaker delays the play out of the identification sound signal due to internal processing such as digital processing, filtering, cross-overs, cables, distance to microphone. In this particular scenario, the internal delays of the speakers are the same or constant and known. If they are constant and known but different, then this is taken into account when determining the time lags at step 410 of FIG. 4. The time-of-arrival of the identification sound signal as determined by the microphone is subject to delays due to the internal delays of the microphone. The internal delays of the microphone may be the same or constant and known. If they are constant and known but different, then this is taken into account when determining the time lags at step 410 of FIG. 4.

If the internal delays in the speaker are unknown but constant, then each time lag measurement comprises this internal delay and an unknown propagation delay. Only the propagation delay part is used to determine the distance between a speaker and the microphone, but both are determined. This is taken into account in step 410 of FIG. 4. When the internal delay in a speaker is unknown, there are twice as many unknowns compared to when the internal delay is known. Thus twice as many relative measurements to unique listening locations are taken. For example, if three listening locations are taken to determine the speaker locations when the internal delays are known or insignificant, then measurements to at least six listening locations are used when the internal delays are not known. Some implementations may use identical speaker units, which have the same internal delays. In this case the number of measurements is reduced accordingly.

In an example implementation, the user is supplied with a 1 m square piece of cardboard or paper, as illustrated on FIG. 3. The user places a microphone at listening location L1. The user then interacts with the user interface of either their mobile phone or the controller, for example by pressing a button. This causes a signal to be transmitted to all of the speakers to be located. That signal indicates to the speakers to playout their identification sound signals immediately. The speakers respond by playing out their identification sound signals. These identification sound signals are orthogonal to each other. The microphone receives the identification sound signals from each of the speakers. The microphone either determines the distance to each speaker as described above, or forwards the received data to the location-determining device to determine the distance to each speaker. The user then moves the microphone to listening location L2. The user interacts with the user interface of their mobile phone or the controller, which causes a signal to be transmitted to all of the speakers to be located. That signal indicates to the speakers to playout their identification sound signals immediately. The speakers respond by playing out their identification sound signals. The microphone receives the identification sound signals at the second listening location L2. The microphone either determines the distance to each speaker or forwards the received data to the location-determining device to determine the distance to each speaker. This process is repeated for listening locations L3 and L4. The locations of the speakers are then determined as described above.

The location-determining device may be configured to determine the location of the speakers without knowledge of the playout time. For example, if the location-determining device is the listening device, it may not have a working data link with the speakers other than the audio signal its microphone receives. In this case each speaker is configured to transmit known, unique and orthogonal identification data simultaneously using controller 322. The configuration of each speaker could be set to transmit its single or periodic information data. Once activated the user instructs the listening device to listen for the known identification data. In this case the playout time is unknown and hence it must be determined. In this case, a further measurement is made from at least one more unique listening location. Since the speakers simultaneously play out their identification sound signals, the relative time of transmission to each listening location of each of the played out identification sound signal is determined using time-difference-of-arrival analysis. The identification sound signals from the speakers are concurrently received by the listening device, and hence the correlation response has the form shown in FIG. 6, with primary peaks representing the time-of-arrival of each of the identification sound signals from the speakers.

The speakers may be configured to play out broadcast audio data. The broadcast audio data is streamed to the speakers from a hub device, which may be controller 322 or another device, via a uni-directional broadcast. For example, the speakers may be configured to play out broadcast audio in accordance with the Connectionless Slave Broadcast of the Bluetooth protocol.

The Connectionless Slave Broadcast (CSB) mode is a feature of Bluetooth which enables a Bluetooth piconet master to broadcast data to any number of connected slave devices. This is different to normal Bluetooth operations, in which a piconet is limited to eight devices: a master and seven slaves. In the CSB mode, the master device reserves a specific logical transport for transmitting broadcast data. That broadcast data is transmitted in accordance with a timing and frequency schedule. The master transmits a synchronisation train comprising this timing and frequency schedule on a Synchronisation Scan Channel. In order to receive the broadcasts, a slave device first implements a synchronisation procedure. In this synchronisation procedure, the slave listens to the Synchronisation Scan Channel in order to receive the synchronisation train from the master. This enables it to determine the Bluetooth clock of the master and the timing and frequency schedule of the broadcast packets. The slave synchronises its Bluetooth clock to that of the master for the purposes of receiving the CSB. The slave device may then stop listening for synchronisation train packets. The slave opens its receive window according to the timing and frequency schedule determined from the synchronisation procedure in order to receive the CSB broadcasts from the master device. The master device, for example controller 322, may broadcast the audio for the different speaker channels. This broadcast is received by the speakers, acting as slaves. The speakers then play out the audio broadcast.

Each speaker may be assigned a speaker channel based on the determined location of the speakers of the speaker system. The location-determining device may transmit the determined locations of the speakers in the speaker system to the controller 322 or mobile device. The controller 322 or mobile device then determines which speaker channel to assign to which speaker, and transmits this assignment to the speaker. The speaker then listens to the assigned speaker channel, and plays out the audio from the assigned speaker channel.

Once the location of at least three speakers in the speaker system is known, then the location of another device which emits sound signals can be determined. For example, the location of a mobile device can be determined by causing the mobile phone to emit a sound from its speaker. Similarly, the location of a user can be determined by the user emitting a sound, such as clicking their fingers. The device to be located emits a sound signal. This sound signal is received at at least three speakers of the speaker system. Each speaker determines the time-of-arrival of the sound signal, and forwards that time-of-arrival to the location-determining device. The location-determining device receives the time-of-arrival of the sound signal at each of the at least three speakers. The location-determining device determines the time-difference-of-arrival of the sound signal at the speakers, and uses this along with the known locations of the speakers to determine the location of the source of the sound signal.

As another example, the location of a device incorporating a microphone can be determined by causing the speakers having the known locations to transmit their identification sound signals. In this case, each speaker transmits its identification sound signal at regular (or known) intervals. The microphone in the device to be located receives a plurality of identification sound signals from each speaker, and measures the time-of-arrival of those identification sound signals. The time-difference-of-arrival of the identification sound signals is determined. This is used, along with the known locations of the speakers to determine the location of the microphone device.

Once the location of the speakers is known, then parameters of audio signals played out from those speakers can be determined so as to align those parameters of the played out audio signals at a further listening location. The speakers are then caused to play out audio signals having those aligned parameters. This improves the quality of the played out audio signals as heard at the further listening location.

For example, the location-determining device can determine the time taken for a signal played out from each speaker to reach the further listening location. For each speaker, this is the distance between that speaker and the further listening location divided by the speed of sound in air. The location-determining device then determines time delays to add to the signals played out from each speaker such that the played out signals from the speakers are time synchronised at the further listening location. For example, the location-determining device may determine the longest time lag of the speakers, and introduce a delay into the timing of the audio playout of all the other speakers so that their audio playout is received at the further listening location synchronously with the audio playout from the speaker having the longest time lag. This may be implemented by the speakers being sent control signals to adjust the playout of audio signals so as to add an additional delay. Alternatively, the device which sends the speakers the audio signals to play out may adjust the speaker channels so as to introduce a delay into the timing of all the other speaker channels. In this manner, the device which sends the speakers the audio signals to play out may adjust the timing of the audio on each speaker's channel so as to cause that speaker to play out audio with the adjusted timing. Thus, subsequent audio signals played out by the speakers are received at the further listening location aligned in time.

As another example, the location-determining device can determine the relative amplitudes of signals played out from each speaker at the further listening location. The location-determining device determines the volume levels of the speakers so as to equalise the amplitudes of received audio signals at the further listening location. The speakers may then be sent control signals to set their volume levels as determined. Alternatively, the device which sends the speakers the audio signals to play out may adjust the speaker channels so as to set the amplitudes of the audio on the speaker channels in order to better equalise the amplitudes of the received audio signals at the further listening location. In this manner, the device which sends the speakers the audio signals to play out may set the amplitude level of the audio on each speaker's channel so as to cause that speaker to play out audio with the determined volume. Thus, subsequent audio signals played out by the speakers are received at the further listening location aligned in amplitude.

As another example, the location-determining device can determine the relative phases of signals played out from each speaker at the further listening location. The phases of future audio signals played out from the speakers are then determined to be set so as to align the phases of the played out signals at the further listening location.

After the speakers have been controlled to play out audio signals having the determined parameters, a check may be performed. This check may be implemented by causing all the speakers to play out their identification data at the same playout time, and then comparing the correlation peaks of the different identification sound signals received at a microphone at the further listening location. If the correlation peaks are aligned in time and amplitude to within a determined tolerance, then the check is successful and no further parameter adjustment is made. If the correlation peaks are not aligned in time and amplitude to within the determined tolerance, then the parameters are adjusted accordingly so as to cause the correlation peaks to be aligned in time and amplitude.

The methods described herein refer to determining the location of the speakers of a speaker system relative to one of the listening locations. This listening location may be defined as the origin, and the determined coordinates of a speaker be relative to that origin. Alternatively, another point may be defined as the origin, and the determined coordinates of the speaker be relative to that origin. In this latter case, the location of the point which is defined as the origin is known relative to the location of one of the listening locations. Hence, the determined coordinates of the speaker are relative to the location of that listening location.

The actual location of a speaker within a speaker product and a microphone within a microphone product are not typically known by a user. Thus, determining the locations of the speakers by manually measuring the distances and angles between the speaker products has limited accuracy. The methods described herein determine the locations of the speakers with greater accuracy than manual measurement as described in the background section.

The time taken for audio signals to be sent from the sound source to each speaker is either the same (if the speakers are stationary and equidistant from the sound source), or constant (if the speakers are stationary but not equidistant from the sound source) and known. For example, the time taken for broadcast audio data to be transmitted from the controller 322 and received by each of the speakers in the speaker system is either the same, or constant and known. If this time is constant and known but different for different speakers, then this may be taken into account in the scenario in which the speakers are controlled to play out their identification sound signals immediately on receipt of an instruction to do so by the controller/mobile device. In other words, the time lag between the playout time and the time-of-arrival of an identification sound signal at a microphone is determined based on the following times in this scenario:

time taken for the audio broadcast to reach the speaker from the sound source,

the time taken for the speaker to process that audio broadcast for playout, and

the time taken for the listener to receive that played out audio from the speaker.

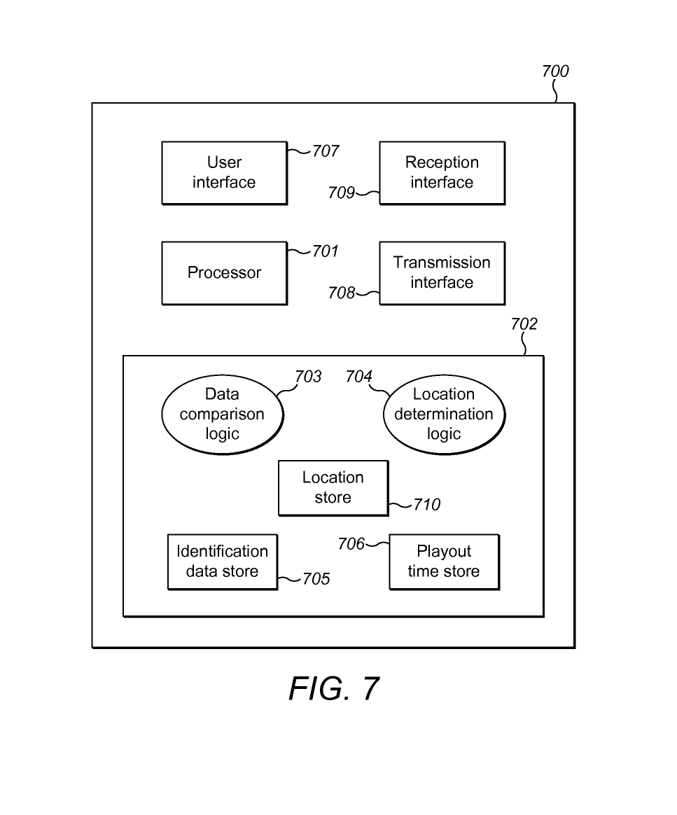

Reference is now made to FIG. 7. FIG. 7 illustrates a computing-based device 700 in which the described controller or mobile device can be implemented. The computing-based device may be an electronic device. The computing-based device illustrates functionality used for transmitting identification data and playout times to a speaker, receiving data indicative of a played out identification sound signal, comparing played out identification sound signals and determining locations of speakers.

Computing-based device 700 comprises a processor 701 for processing computer executable instructions configured to control the operation of the device in order to perform the location determination method. The computer executable instructions can be provided using any non-transient computer-readable media such as memory 702. Further software that can be provided at the computer-based device 700 includes data comparison logic 703 which implements step 410 of FIG. 4, and location determination logic 704 which implements steps 410 and 412 of FIG. 4. Alternatively, the controller for performing the data comparison and location determination are implemented partially or wholly in hardware. Store 705 stores the identification data of each speaker. Store 706 stores the playout time of the identification data of each speaker. Store 710 stores the locations of the speakers of the speaker system. Computing-based device 700 also comprises a user interface 707. The user interface 707 may be, for example, a touch screen, one or more buttons, a microphone for receiving voice commands, a camera for receiving user gestures, a peripheral device such as a mouse, etc. The user interface 707 allows a user to control the initiation of a location-determining process, and to manually adjust parameters of the audio signals played out by the speakers. The computing-based device 700 also comprises a transmission interface 708 and a reception interface 709. The transmitter and receiver collectively include an antenna, radio frequency (RF) front end and a baseband processor. In order to transmit signals the processor 701 can drive the RF front end, which in turn causes the antenna to emit suitable RF signals. Signals received at the antenna can be pre-processed (e.g. by analogue filtering and amplification) by the RF front end, which presents corresponding signals to the processor 701 for decoding.

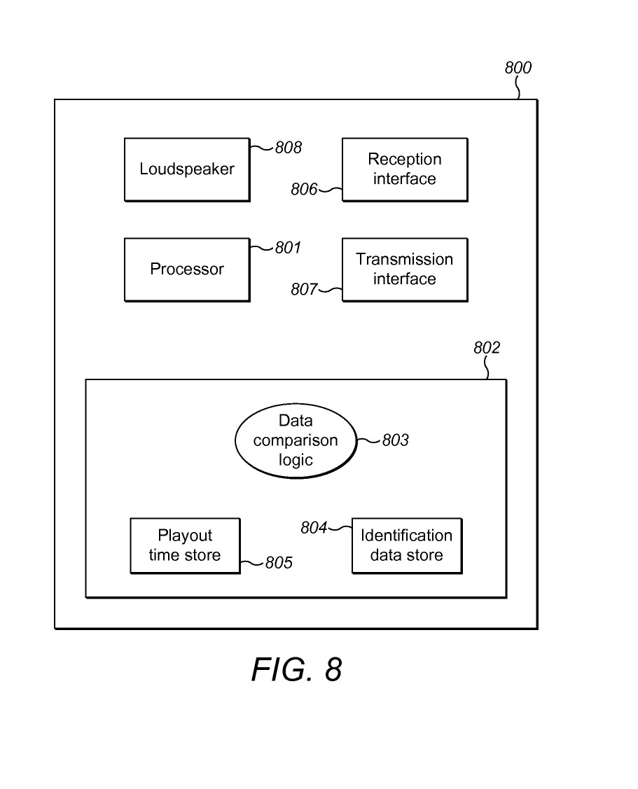

Reference is now made to FIG. 8. FIG. 8 illustrates a computing-based device 800 in which the described speaker can be implemented. The computing-based device may be an electronic device. The computing-based device illustrates functionality used for receiving identification data and playout times, playing out identification sound signals, and playing out audio signals.

Computing-based device 800 comprises a processor 801 for processing computer executable instructions configured to control the operation of the device in order to perform the reception and playing out method. The computer executable instructions can be provided using any non-transient computer-readable media such as memory 802. Further software that can be provided at the computer-based device 800 includes data comparison logic 803. Alternatively, the data comparison may be implemented partially or wholly in hardware. Store 804 stores the identification data of the speaker. Store 805 stores the playout time of the identification data of the speaker. Computing-based device 800 further comprises a reception interface 806 for receiving signals from the controller and/or mobile device and sound source. The computing-based device 800 may additionally include transmission interface 807. The transmitter and receiver collectively include an antenna, radio frequency (RF) front end and a baseband processor. In order to transmit signals the processor 801 can drive the RF front end, which in turn causes the antenna to emit suitable RF signals. Signals received at the antenna can be pre-processed (e.g. by analogue filtering and amplification) by the RF front end, which presents corresponding signals to the processor 801 for decoding. The computing-based device 800 also comprises a loudspeaker 808 for playing the audio out locally at the playout time.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A controller for determining the location of speakers in a system of speakers configured to play out audio signals received according to a wireless communications protocol, the controller configured to:
for each speaker of the system of speakers, transmit a signal to that speaker comprising an indication of a playout time for playing out an identification sound signal comprising identification data of that speaker;
receive data indicative of a played out identification sound signal from each speaker as received at at least two listening locations, wherein relative positional information about the at least two listening locations is known;
for each of the at least two listening locations, compare the relative time of transmission to that listening location of each of the played out identification sound signals; and
based on those comparisons, determine the locations of the speakers of the speaker system relative to the position of one of the at least two listening locations.

2. A controller as claimed in claim 1, configured to, for each speaker of the system of speakers, transmit one or more signals to that speaker comprising indications of threat least two playout times for playing out an identification sound signal comprising the identification data of that speaker.

3. A controller as claimed in claim 1, configured to transmit the same indication of the playout time to each speaker of the system of speakers.

4. A controller as claimed in claim 1, configured to transmit different indications of the playout time to each speaker of the system of speakers.

5. A controller as claimed in claim 1, configured to, for each speaker of the system of speakers, transmit a signal to that speaker comprising the identification data for that speaker.

6. A controller as claimed in claim 5, wherein the signal comprising the identification data for a speaker and the signal comprising an indication of a playout time for that speaker form part of the same signal.

7. A controller as claimed in claim 1, wherein the identification data for each speaker is orthogonal to the identification data of the other speakers in the system of speakers.

8. A controller as claimed in claim 1, wherein the identification sound signal for each speaker is an identification chirp sound signal.

9. A controller as claimed in claim 1, wherein the positions of three listening locations are known relative to each other.

10. A controller as claimed in claim 1, wherein the direction of the second listening location relative to the first listening location is known.

11. A controller as claimed in claim 1, wherein the positions of two listening locations are known relative to each other, and the direction of one speaker of the system of speakers is known relative to the position of one of the two listening locations.

12. A controller as claimed in claim 1, further comprising a store, wherein the controller is configured to:
store each speaker's identification data; and
perform the claimed comparison by:
(i) correlating the received data indicative of played out identification sound signals received from the speakers against the stored identification data to form a correlation response; and
(ii) determining the locations of the speakers of the speaker system relative to the position of one of the at least two listening locations based on the correlation response.

13. A controller as claimed in claim 1, further configured to assign a channel to each speaker based on the determined locations of the speakers.

14. A controller as claimed in claimed in claim 1, further configured to:
determine parameters of audio signals played out from the speakers so as to align those played out audio signals at a further listening location; and
control the speakers to play out audio signals with the determined parameters.

15. A controller as claimed in claim 13, wherein the controller is configured to determine amplitude of audio signals played out from the speakers so that the amplitudes of the played out audio signals are matched at the further listening location.

16. A controller as claimed in claim 13, wherein the controller is configured to determine playout time of audio signals played out from the speakers so that the played out audio signals are time synchronised at the further listening location.

17. A controller as claimed in claim 13, wherein the controller is configured to determine phase of audio signals played out from the speakers so that the phases of the played out audio signals are matched at the further listening location.

18. A controller as claimed in claim 1, configured to:
receive data indicative of a sound signal emitted by an object as received at at least three speakers of the system of speakers; and
determine the location of the object by comparing the time-of-arrival of the sound signal at each of the at least three speakers of the system of speakers.

19. A controller as claimed in claim 1, wherein internal delays at the speakers are unknown to the controller, the controller being configured to:
receive data indicative of a played out identification sound signal from each speaker as received at a further at least two listening locations, wherein relative positional information about the at least two listening locations and the further at least two listening locations is known;
for each of the at least two listening locations and further at least two listening locations, compare the relative time of transmission to that listening location of each of the played out identification sound signals, thereby determining the time of flight of each identification sound signal from the speaker to the listening location and the internal delay of the speaker; and
based on those comparisons, determine the location of the speakers of the speaker system relative to the position of one of the at least two listening locations.

20. A method of determining the location of speakers in a system of speakers configured to play out audio signals received according to a wireless communications protocol, the method comprising:
for each speaker of the system of speakers, transmitting a signal to that speaker comprising an indication of a playout time for playing out an identification sound signal comprising identification data of that speaker;
receiving data indicative of a played out identification sound signal from each speaker as received at at least two listening locations, wherein relative positional information about the at least two listening locations is known;
for each of the at least two listening locations, comparing the relative time of transmission to that listening location of each of the played out identification sound signals; and
based on those comparisons, determining the locations of the speakers of the speaker system relative to the position of one of the at least two listening locations.
